(19) United States
(12) Patent Application Publication
(10) Pub. No.: US 2022/0088877 A1
(43) Pub. Date: Mar. 24, 2022

(54) Repeating Layer System and Method

(71) Applicant: Vivet Technology LLC, Dearborn, MI (US)

(72) Inventors: Amjad Qusay Hashem, Dearborn, MI (US); Qais Alsawafy, Dearborn, MI (US)

(21) Appl. No.: 17/332,452

(22) Filed: May 27, 2021

Related U.S. Application Data
(60) Provisional application No. 63/081,474, filed on Sep. 22, 2020.

(51) Int. Cl. B29C 64/393; B33Y 50/02

(52) U.S. Cl. CPC B29C 64/393; B33Y 50/02

(57) ABSTRACT

A repeating layer system may provide operations to generate one or more layers of a product having a layer quantity based on an assembly arrangement of layering devices for transforming the product between an uncompleted configuration and a completed configuration, generate at least one of an operation portion, operation quantity, operation type, cycle time, or pass quantity for the one or more layers, and cause movement of the product through the layering devices according to at least one of the layer quantity, operation portion, operation quantity, operation type, cycle time or pass quantity for the one or more layers.

### CROSS-REFERENCE TO RELATED APPLICATIONS

This US Non-Provisional Patent Application is based on and claims priority to U.S. Provisional Patent Application No. 63/081,474 filed Sep. 22, 2020, which is hereby incorporated by reference in its entirety.

### BACKGROUND

Traditional platforms include overly complex, stand-alone machines that perform multiple operations using a linear process through completion of each product. Typical machines perform multi-step operations on every product in series. Traditional devices may perform complex operations using a single machine with numerous high-performance operations. This results in a process that is expensive, time intensive and produces reduced production volumes.

There is a need for systems and methods as disclosed herein that solve the above problems. There is a need for a system that distributes operations into respective repeating layers for which operation portions are handled by respective machines or devices of an assembly arrangement of layering devices. This reduces the complexity of each machine to lower initial, operational and expansion costs while increasing non-recurring engineering. This disclosure provides advantages and solutions over prior platforms.

### BRIEF DESCRIPTION OF THE DRAWINGS

FIG. 1 illustrates an exemplary system of the present disclosure;

FIG. 2 illustrates another exemplary system of the present disclosure;

FIG. 3 illustrates another exemplary system of the present disclosure;

FIG. 4 illustrates another exemplary system of the present disclosure;

FIG. 5 illustrates an exemplary method including a process flow of the present disclosure; and

FIG. 6 illustrates an exemplary system including a product of the present disclosure.

### DETAILED DESCRIPTION

The present disclosure relates to systems and methods for improved assembly and manufacturing methodologies for all types of products including one or more parts, sub-parts, assemblies, sub-assemblies, assembly systems, or a combination thereof. Systems are configured to utilize layers (e.g., repeating layers) of sub-parts (e.g., product portions) and/or operations (e.g., operation portions) of a product. The system is configured to continually perform operations until the number of layers is completed and then remove the product from the system. The repeating layer may include one or multiple parts that may be added to or removed from the product, one or multiple operations performed on the product, or a combination thereof. The system may include operations including to generate or define a repeating layer for a product by determining a quantity of layers to be processed, a quantity of layers to process on each pass of the product through the system, and a quantity of passes that the product will have through the system for completion.

The system may be arranged as an assembly or manufacturing system with various advantages and improvements over traditional platforms. The system has various advantages including improved cost effectiveness, operational costs, scalability, throughput, and physical footprint. The system provides an improved initial starting cost by including and utilizing distributed stations with layering devices (e.g., assembly and/or manufacturing devices) configured and adapted to respective operation portions, e.g., reducing the size and complexity of each device, and this may be repeated throughout the system. The system provides improved operational cost by utilizing similar operations by similar devices with common maintenance, repair, and spare parts. The system is scalable by adding additional repeating layers to each pass of the system. The system replaces multiple stand-alone platforms with traditional techniques. The system has a reduced physical footprint as expansion is accomplished by adding repeating layers rather than a completely new platform.

The system may be utilized for any product or industry including food, pharmaceutical, aerospace, automotive, consumer products, etc. The system may be implemented in any packaging, knitting, assembly, manufacturing, machining, or other operation.

The system and method may include operations for a repeating layer process. The operations may include generating one or more repeating layers of a product having a layer quantity based on an system of layering devices for transforming the product between an uncompleted configuration and a completed configuration, generating an operation portion, operation quantity, operation type, cycle time, and pass quantity for the one or more repeating layers, and causing movement of the product through the layering devices according to the defined layer quantity, operation portion, operation quantity, operation type, cycle time and/or pass quantity for the one or more repeating layers, and adapting the system by changing a layer, operation and/or layering device for the one or more repeating layers. For example, the system may increase throughput by increasing the layer quantity or operation quantity, operation type, reducing the cycle time or pass quantity, or a combination thereof.

An exemplary system and method may include manual, automatic or semi-automatic operations. The system may define one or more repeating layers according to a type, time, quantity and/or complexity of an operation, cycle, part, material, or a combination thereof. The system may include one or a series of assembly, testing, and/or transfer devices configured to perform one or more operations on one or more respective layers of a product, test and verify the product relative to a verification threshold and transfer the product upon meeting the verification threshold. Exemplary operations may include part presence verification, part quality verification, part acceptability verification, press operations, fastener (e.g., bolt) rundown operations, or a combination thereof.

An embodiment may include a system and method for product filling and/or packaging such as canning. The system may include operations relative to a can, a liquid, and cap. The system may define respective repeating layers according to a first placement operation (e.g., placing the can), a fill operation (e.g., filling the can with the liquid), a verification option (e.g., a sensor such as an optical sensor for measuring a liquid level relative to a level threshold), a second placement operation (e.g., placing the top on the can), a test operation (e.g., a sensor measuring an assembled weight relative to a weight threshold).

Another embodiment may include a system and method for building a vehicle, an engine, or components thereof. The system may define respective repeating layers according to a component placement operation, a press operation, a torque operation, and a verification operation.

An embodiment may also include a system and method for circuit boards. The system may include operations relative to a printed circuit board and one or more resistors, capacitors, conductors, diodes, and chips. The system may define respective repeating layers according to predefined quantities and types of components. The respective repeating layers may include a first placement operation of one or more chips, a second placement of one or more resistors and capacitors, a third placement operation of one or more resistors, capacitors, and conductors. One or more repeating layers may repeat or change over time.

An embodiment may include a system and method for a battery. The repeating layers may be defined according to batteries, packs, modules, or cells, e.g., repeating according to the number of components (e.g., cells) to complete an assembly (e.g., module). The respective repeating layers may include a first placement operation (e.g., placing a tube for a cylindrical cell), a second placement operation (e.g., placing a roll), a third placement operation (e.g., placing a filter), a fill or forth placement operation (e.g., filling liquid), and a closure or fifth placement operation (e.g., placing the cap). The system may repeat the repeating layer according to a quantity of components (e.g., cells) to complete an assembly (e.g., module).

The system and method herein may be configured for a variety of other operations. This may include food cans, vaccines, pharmaceuticals vials, solar panels, transmissions, vehicle bodies, weld lines, or lighting (e.g., light emitting diode (LED)) assemblies. The system and method may employ differing and/or varying layers. For example, a first layer may include a first number of parts (e.g., four), a second layer through a tenth layer may include a second number of parts (e.g., two), and an eleventh layer may include a third number of parts (e.g., three). The systems and processes can utilize any part transport system for palletized or unpalletized parts.

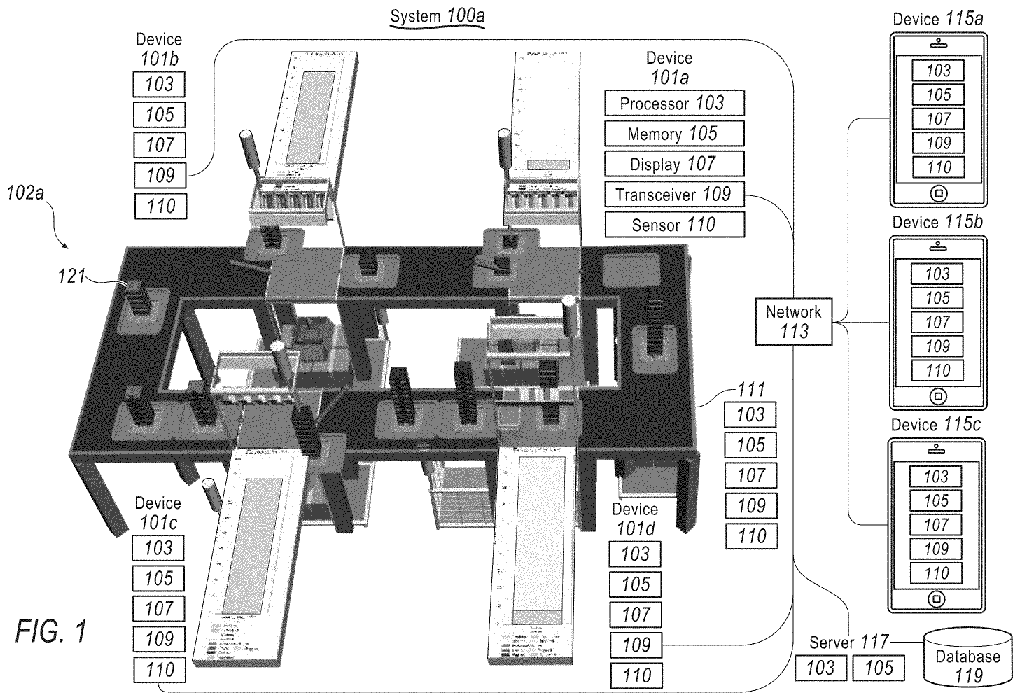

FIGS. 1-6 illustrate an exemplary system 100, process 200, and system 300 related to, for example, a repeating layer system, method, and product. System 100, process 200, and system 300 may take many different forms and include multiple and/or alternate components, structures, and arrangements. While an exemplary systems, devices, and methods are shown, the exemplary components are not intended to be limiting, and additional or alternative components and/or implementations may be used.

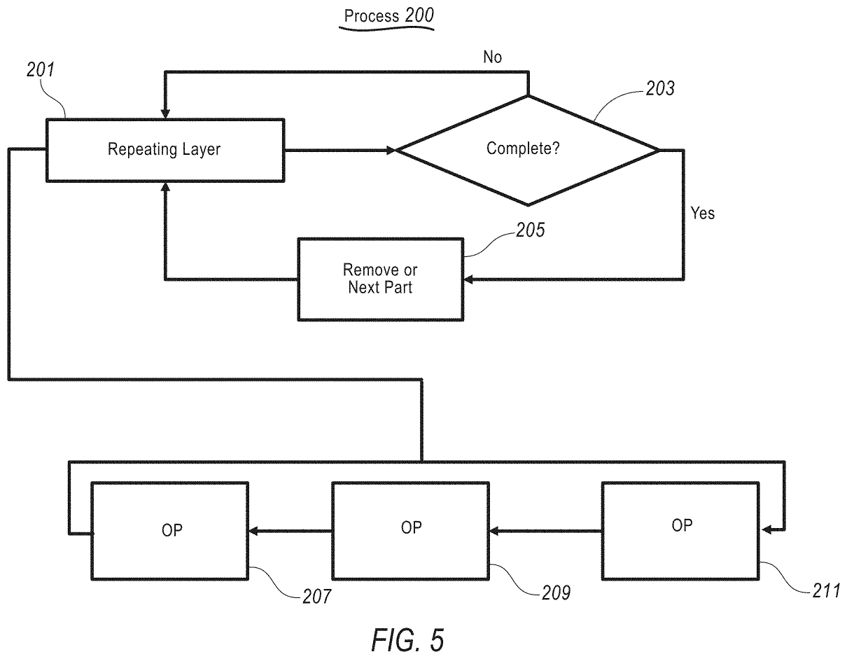

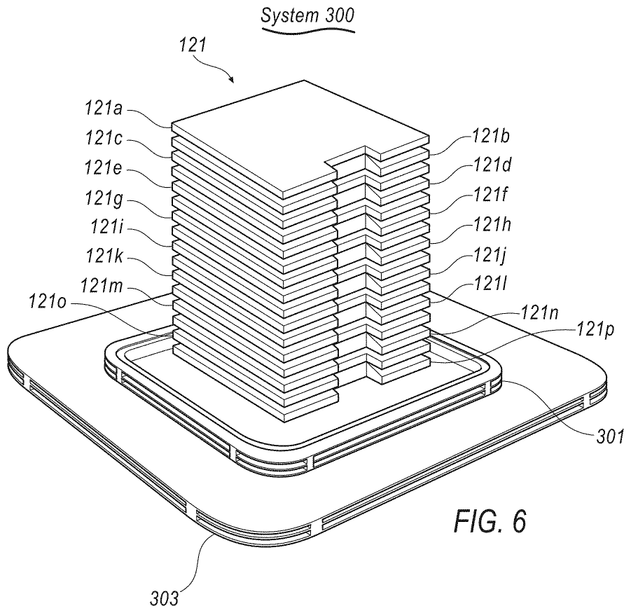

FIGS. 1-4 illustrate exemplary systems 100 (e.g., systems 100a,b,c,d), e.g., a repeating layer system. FIG. 5 illustrates process 200 of systems 100, e.g., a repeating layer method. FIG. 6 illustrates an exemplary product of systems 100, e.g., a product of a repeating layer system and method.

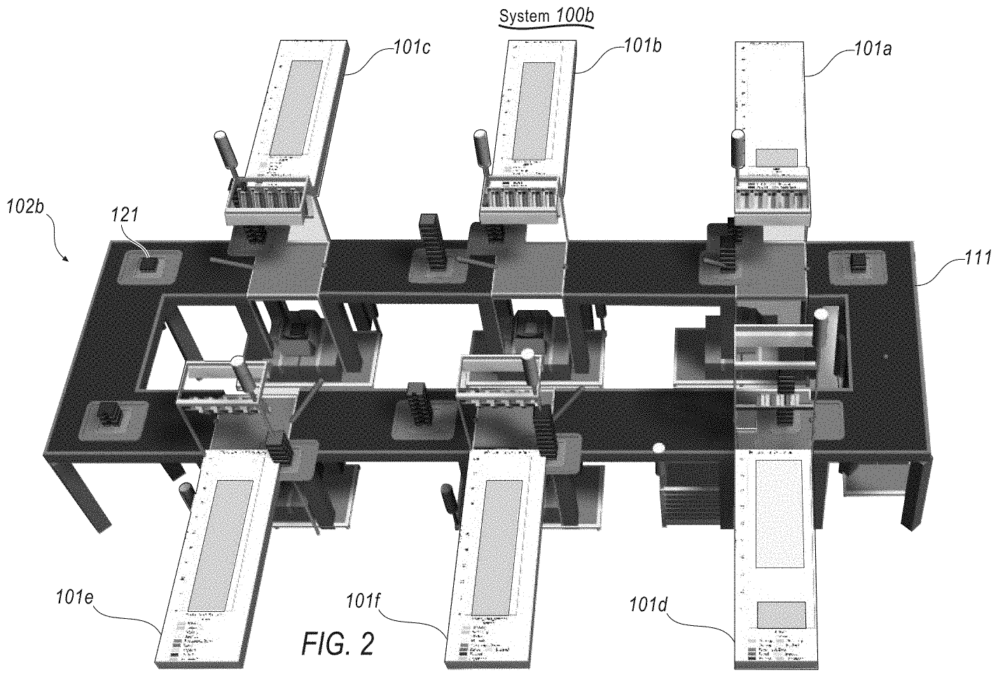

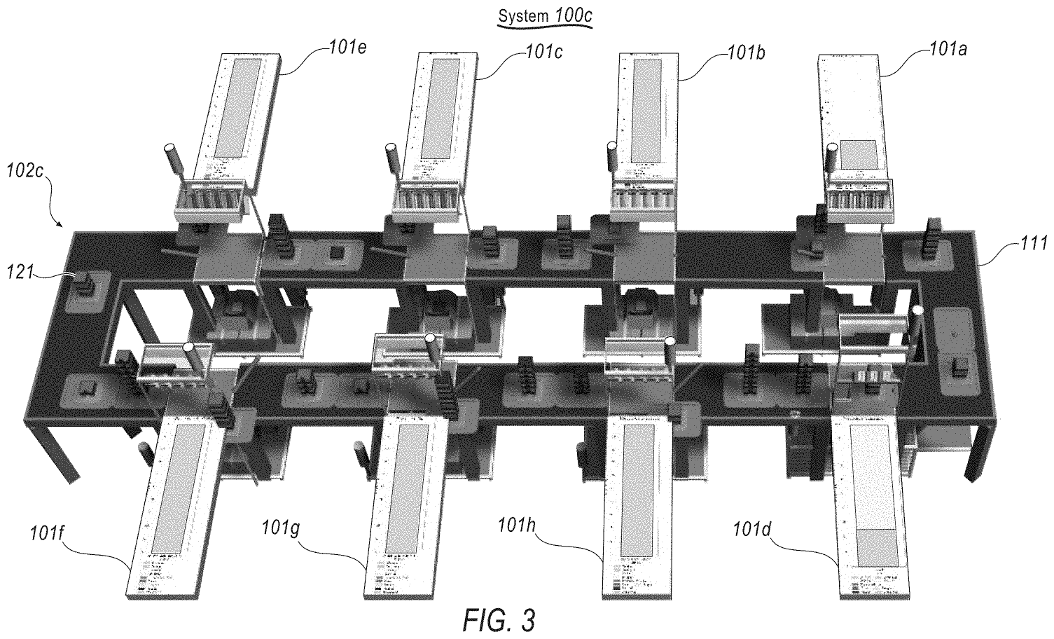

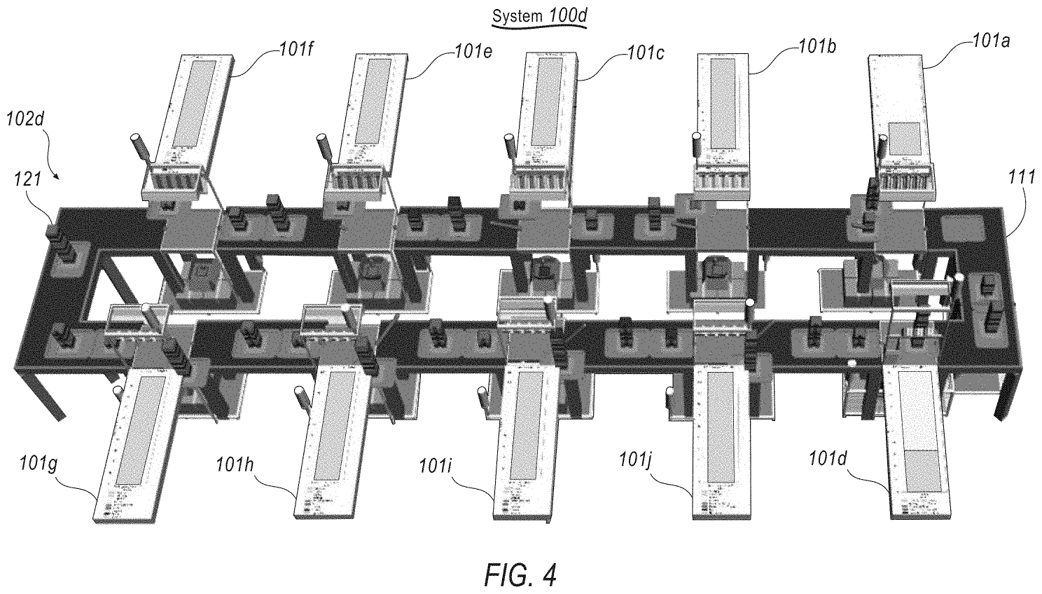

As examples of the present disclosure, FIGS. 1-6 illustrate exemplary embodiments of system 100 (e.g., repeating layer system), process 200 (e.g., repeating layer process), and system 300 (e.g., repeating layer product). FIG. 1 illustrates an exemplary system 100a having repeating layers such as a first layer that may include an unload operation, layers two through eight may include first placement operations for one or more components (e.g., two), and a ninth layer as an unload operation. FIG. 2 illustrates an exemplary system 100b having repeating layers such that additional stations for components with each layer or task building two or more layers rather than one layer. FIG. 3 illustrates an exemplary system 100c having repeating layers such that every pass employs at least three layers. FIG. 4 illustrates an exemplary system 100d having repeating layers such that every pass employs at least four layers for two passes total. FIG. 5 illustrates an exemplary system 100e having repeating layers such that additional repeating layers are employed until layer completion followed by removal of the part and/or intake of the next part. FIG. 6 illustrates an exemplary system 300 including an example product of the present disclosure (e.g., a repeating layer product). All or any portion of one or more embodiments herein may be interchangeable with any other embodiments herein.

Referring again to FIGS. 1-4, system 100 may include an assembly system (e.g., repeating layer system) having one or more of devices 101 (e.g., layering devices 101a,b,c,d,e,f,g,h,i,j), processor 103 (e.g., hardware processor), memory 105 (e.g., physical memory), display 107 (e.g., hardware display or screen for displaying a user interface), transceiver 109 (e.g., hardware transceiver), sensor 110, transport system 111 (e.g., tray transport), network 113, device 115 (e.g., computing devices 115a,b,c), server 117 and database 119. Any component of system 100 may include processor 103, memory 105, display 107, transceiver 109 and network 113 may be configured store, communicate, display, and adapt information and transfer the information with respect to any other component therein.

System 100 may provide information that may include or relate to any of the operations herein, instructions executed by processor 103, processes (e.g., one or more repeating layer process), user inputs, outputs, heuristics, user interfaces, sensor information, cycle time, parts/jobs per hour, parts/jobs per year, geospatial information, location, x-y gantry, x-y-z position, proximity, time, temperature, quality, transparency, weight, part, machine and/or user information, or any combination thereof.

System 100 may communicate, by way of processor 103, memory 105, display 107, transceiver 109 and network 113, any information between one or more device 101 (e.g., devices 101a-j), device 115 (e.g., devices 115a-c), server 117, database 119, or any combination thereof. Device 101 may include any machine configured to perform one or more processing, machining, assembly and/or tooling operations including, e.g., feed tray transport, empty tray transport, assembly tray transport, stacker, operator device, xy or xyz gantry, robot, actuator, or a combination thereof. Devices 101, 115 may include one or a combination of computing, input-output, display and/or hardware devices such as a computer, mobile phone, smartphone, desktop, laptop, tablet, headset, handheld, watch and/or touchscreen device. System 100 may adapt by processor 103 and/or display 107 any information and operations herein. Devices 101, 115 and transport system 111 may include one or more sensor 110 to provide sensor information and/or to trigger any of the operations herein, e.g., identify respective parts having completed, defective and unfinished layers.

In embodiments, system 100a may be configured to add parts by device 101a (e.g., feed tray transport) to transport system 111, perform a predefined number of operations of a repeating layer process by respective devices 101b-c, 101e-j (e.g., stacker, operator device, xy or xyz gantry, robot and/or actuator), identify finished, defective and unfinished parts by sensor 110, transfer completed parts to an finished container or defective parts to a discard container by device 101d (e.g., empty tray transport), and maintain unfinished parts on transport system 111 for a next or additional repeating layer process by system 100 by way of transport system 111 and devices 101b-c, 101e-j

As shown in FIG. 1, system 101a may include an assembly system. System 101 may include device 101a (e.g., tray feed transport), first operation device 101b (e.g., first operation portion of one or more repeating layers), second operation device 101c (e.g., second operation portion of the one or more repeating layers), and device 101d (e.g., empty tray transport). Device 101a may be configured to transfer parts having one or more unfinished layers between an incoming container and transport system 111. Transport system 111 may be configured to position parts relative to devices 101b-d. Devices 101b-c may perform the first and second operation portions of the one or more repeating layers. The operation portions may be performed sequentially or simultaneously by devices 101 for a first predefined or sensor-defined threshold, e.g., based on the information disclosed herein.

Transport system 111 may transfer parts between any of devices 101 (e.g., devices 101b and 101c) for processing of the second operation portion of the one or more repeating layers. Transport system 111 and devices 101b-d may transfer parts with completed layers between transport system 111 and a finished container, those with defective layers between transport system 111 and a discard container, and those with unfinished layers proceed on transport system 111 for continued processing by devices 101b-d.

Transport system 111 may perform one or more additional cycles of one or more operation portions of the one or more repeating layer for one or more additional predefined or sensor-defined threshold (e.g., the same as or different than the first or other thresholds) until the remaining parts have been transferred to the respective discard and finished containers by devices 101b-d. The improvements of system 100a may provide advantages including a cycle time of about 1 minutes, 10 seconds, jobs per hour of about 51, and jobs per year of about 238,404.

Referring to FIG. 2, system 101b that may further include third operation device 101e and forth operation device 101f associated with respective third and fourth operation portions of the one or more repeating layers. Transport system 111 may be configured to position parts relative to devices 101b-f for processing of the first, second, third and fourth operations of each repeating layer. The improvements of system 100b may provide advantages including a cycle time of about 35 seconds, jobs per hour of about 103, and jobs per year of about 477,084 thereby increasing production by a factor in the range of about two over system 100a.

FIG. 3 illustrates system 101c that may further include fifth operation device 101g and sixth operation device 101h associated with respective fifth and sixth operation portions of the one or more repeating layers. Transport system 111 may be configured to position parts relative to devices 101b-h for processing of the first, second, third, fourth, fifth and sixth operations of each repeating layer by respective devices 101b-h. The improvements of system 100c may provide advantages including a cycle time of about 20 seconds, jobs per hour of about 179, and jobs per year of about 834,496 thereby increasing production by a factor in the range of about four over system 100a.

With reference to FIG. 4, system 101d may further include seventh operation device 101i and eighth operation device 101j associated with respective seventh and eighth operation portions of the one or more repeating layers. Transport system 111 may be configured to position parts relative to devices 101b-j for processing of the first, second, third, fourth, fifth and sixth, seventh and eighth operations of each repeating layer by respective devices 101b-j. The improvements of system 100d may provide advantages including a cycle time of about 15 seconds, jobs per hour of about 240, and jobs per year of 1,112,29 thereby increasing production by a factor in the range of about five over system 100a.

FIG. 5 illustrates an exemplary process 200 of system 100 including, a repeating layer process including operations provided by way of one or more device 101, device 115, processor 103, memory 105, and display 107, transceiver 109, transport system 111 and network 113. This process may take many different forms and include multiple and/or alternate steps, components, and arrangements. While an exemplary process is shown, the exemplary steps are not intended to be limiting, and additional or alternative steps, components and/or implementations may be used. For example, processor 103, in communication with memory 105, display 107 and transceiver 109 and network 113, may generate the information and operations herein for predefined or real-time sensing, feedback and adaptation.

At step 201, system 100 may execute, by processor 103, a repeating layer process. Repeating layer process may include one or more of operations 207, 209 and 211 of respective devices 101 in communication with network 113 and devices 115.

At step 203, system 100 may determine, by one or more sensor 110 of transport system 111 and devices 101, whether a first repeating layer process for one or more parts is finished, defective or unfinished.

At step 205, system 100 may remove one or more parts for which the first repeating layer process is finished or defective, proceed to one or more other parts or repeating layers, or a combination thereof.

At steps 207, 209 and 211, system 100 may perform one or more operation portions. After steps 207, 209 and 211, process 200 may return to step 203 or any other step, or process 200 may stop or repeat.

FIG. 6 illustrates system 300 including an exemplary product 121 including layers 121a-p, fixture 301, and tray 303. System 100 may employ process 200 to produce product 121. System 100 and/or process 200 may define one or more of layers 121a-p according to respective operations. System 100 and process 200 may be predefined and adapt system 300 according to one or more of a layer quantity, operation portion, operation quantity, operation type, cycle time, pass quantity, or a combination thereof.

For example, a first operation may perform a first predefined set of layers (e.g., layer 121a), a second operation may perform a second predefined set of layers (e.g., layers 121b,c), a third operation may perform a third predefined set of layers (e.g., layers 121d,e,f), a fourth operation may perform a fourth predefined set of layers (e.g., layers 121g,h,i,j,k,l,m,n,o,p), or any combination thereof. System 100 and/or process 200 may adapt production of system 300 in response to changes to the layer quantity, operation portion, operation quantity, operation type, cycle time, pass quantity, or a combination thereof.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. Embodiments of the present disclosure are capable of modification and variation.

All terms used in the claims are intended to be given their broadest reasonable constructions and their ordinary meanings as understood by those knowledgeable in the technologies described herein unless an explicit indication to the contrary is made herein. Use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A repeating layer system for providing operations comprising:
generate one or more layers of a product having a layer quantity based on an assembly arrangement of layering devices for transforming the product between an uncompleted configuration and a completed configuration;
generate at least one of an operation portion, operation quantity, operation type, cycle time, or pass quantity for the one or more layers; and
causing movement of the product through the layering devices according to at least one of the layer quantity, operation portion, operation quantity, operation type, cycle time or pass quantity for the one or more layers.

2. The repeating layer system of claim 1, the operations further comprising remove the product and accepting another product after completion of the one or more layers.

3. The repeating layer system of claim 1, the operations further comprising adapt the assembly arrangement by changing at least one of:
the one or more layers,
the operation portion, or
the layering devices.

4. The repeating layer system of claim 1, the operations further comprising increasing throughput by increasing at least one of the layer quantity or the operation quantity.

5. The repeating layer system of claim 1, the operations further comprising increasing throughput by reducing at least one of the cycle time or the pass quantity.

6. The repeating layer system of claim 1, further comprising improve throughput by dynamically adjusting least one of an operation portion, operation quantity, operation type, cycle time, or pass quantity for the one or more layers of the product.

7. The repeating layer system of claim 1, further comprising automatically adapt at least one of an operation portion, operation quantity, operation type, cycle time, or pass quantity for the one or more layers of the product in response to sensor information.

8. A repeating layer device for providing operations comprising:
generate one or more layers of a product having a layer quantity based on an assembly arrangement of layering devices for transforming the product between an uncompleted configuration and a completed configuration,
generate at least one of an operation portion, operation quantity, operation type, cycle time, or pass quantity for the one or more layers, and
cause movement of the product through the layering devices according to at least one of the layer quantity, operation portion, operation quantity, operation type, cycle time or pass quantity for the one or more layers.

9. The repeating layer device of claim 7, further comprising removing the product and accepting another product after completion of the one or more layers.

10. The repeating layer device of claim 7, the operations further comprising adapt the assembly arrangement by changing at least one of:
the one or more layers,
the operation portion, or
the layering devices.

11. The repeating layer device of claim 7, the operations further comprising increasing throughput by increasing at least one of the layer quantity or the operation quantity.

12. The repeating layer device of claim 7, the operations further comprising increasing throughput by reducing at least one of the cycle time or the pass quantity.

13. The repeating layer device of claim 7, the operations further comprising dynamically improve throughput by adjusting least one of an operation portion, operation quantity, operation type, cycle time, or pass quantity for the one or more layers of the product.

14. The repeating layer device of claim 7, the operations further comprising automatically adapt at least one of an operation portion, operation quantity, operation type, cycle time, or pass quantity for the one or more layers of the product in response to sensor information.

15. A repeating layer method comprising:
generating one or more layers of a product having a layer quantity based on an assembly arrangement of layering devices for transforming the product between an uncompleted configuration and a completed configuration,
generating at least one of an operation portion, operation quantity, operation type, cycle time, or pass quantity for the one or more layers, and
causing movement of the product through the layering devices according to at least one of the layer quantity, operation portion, operation quantity, operation type, cycle time or pass quantity for the one or more layers.

16. The repeating layer method of claim 15, further comprising removing the product and accepting another product after completion of the one or more layers.

17. The repeating layer method of claim 15, further comprising adapting the assembly arrangement by changing at least one of:
the one or more layers,
the operation portion, or
the layering devices.

18. The repeating layer method of claim 15, further comprising increasing throughput by increasing at least one of the layer quantity or the operation quantity.

19. The repeating layer method of claim 15, further comprising increasing throughput by reducing at least one of the cycle time or the pass quantity.

20. The repeating layer method of claim 15, the operations further comprising dynamically improving throughput by adjusting least one of an operation portion, operation quantity, operation type, cycle time, or pass quantity for the one or more layers of the product.
